(19) United States
(12) Patent Application Publication
(10) Pub. No.: US 2004/0048231 A1
(43) Pub. Date: Mar. 11, 2004

(54) Method and apparatus to encourage use of dental floss

(76) Inventor: B. Michael Perlin, San Diego, CA (US)

Correspondence Address: DONN K. HARMS, PATENT & TRADEMARK LAW CENTER, SUITE 100, 12702 VIA CORTINA, DEL MAR, CA, 92014, US

(21) Appl. No.: 10/236,212

(22) Filed: Sep. 6, 2002

(51) Int. Cl. G09B 23/28

(52) U.S. Cl. 434/263

(57) ABSTRACT

In a method of encouraging a person to use dental floss, the person is educated that using dental floss promotes a healthy tooth. Dental floss is provided in a container (10) having a shape, and color that signifies a healthy tooth (20)(30). In some aspects the dental floss container (10) has a shape of a tooth (20)(30). Alternative containers (10) may have a shape of dentures (110). In further aspects, the dental floss is flavored with an aroma of a fruit, and the dental floss container (10) has a shape of the fruit (FIGS. 3a-3f).

### FIELD OF THE INVENTION

This application claims the benefit of WIPO Application No.

We 01/6798 filed Mar. 10, 2000. The field of the invention is dental hygiene.

### BACKGROUND OF THE INVENTION

Cleaning interdental spaces utilizing dental floss is an important part of dental hygiene, and basic dental floss is known in the art for many years. However, basic dental floss tends to shred or break, or may have other undesirable qualities that tend to discourage a person from regularly using dental floss.

Therefore, various efforts have been made to help overcome at least some of the problems and consequently to encourage a person to more regularly use dental floss.

Some efforts have been directed towards improving the material composition of the dental floss. For example, while nylon or polyethylene threads are employed in some dental flosses to prevent breakage, other dental flosses utilize Gore-Tex or polytetrafluoroethylene (PTFE) to assist gentle abrasion of plaque. To further improve shred resistance and gliding characteristics of the dental floss, it is known to shape the dental floss in a substantially flat configuration (i.e., a tape) or to coat the dental floss with wax or other hydrophobic materials. Furthermore, the dental floss may be coated or impregnated with a scented or aromatized composition to augment the aesthetic appeal. Although improved materials for dental floss generally help to reduce breakage or to improve gliding, one may perceive the improvement as rather a reduction in annoyance than a motivation to regularly floss.

Other efforts have been directed toward the packaging of the dental floss. Typically, dental floss is packaged in a generally box-shaped container. While a box-shaped container may be sufficient for mere storage of the dental floss, box-shaped containers tend to be unattractive, and are often impracticable where such containers are carried with a person, and therefore reduce the likelihood of using dental floss. To overcome at least some of the problems associated with trapezoid shaped containers, Endclsoh, R. A. describes in U.S. Pat. No. 4,327,755 a credit card shaped dental floss container, which can conveniently be carried in a person's wallet. However, by employing a credit card shaped container, the supply of dental floss is limited to a relatively low quantity, thereby discouraging a user to frequently use the dental floss. In another example, U.S. Pat. No. Des 311,259 to R. M. Smith, a dental floss container is in the shape of an anthropomorphic tooth. Despite the creative tooth-shaped dental floss container may tend to serve more as a toy than as an instructional tool to encourage use of dental floss. In still another example, the “Plaque Attacker Dental Floss Knot,” a package is entirely omitted and a plurality of precut dental floss is bundled together in a knot. Despite the advantage of providing precut segments of dental floss, potential problems may arise due to the exposure of the remaining precut segments of dental floss to moisture or other undesirable hygienic conditions, thereby rendering floss knots often unattractive to users.

In still other efforts, dental floss is replaced by a rotating filament that is inserted into an interdental space (e.g., Interclean Appliance by Braun/OralB). Cleaning of interdental spaces with a rotating filament is advantageous because rotating filaments are generally less damaging to the gingiva surrounding the teeth. However, cleaning with rotating filaments typically requires the purchase of a battery-operated device, and the filaments have to be periodically replaced which further adds significant costs. To overcome at least some of the problems associated with rotating filaments, interdental spaces may also be cleaned with a focused stream of water from an oral irrigator. Oral irrigation is especially desirable where bridges, dentures or crowns at least partially obstruct or prohibit the use of dental floss. However, the use of oral irrigators is in general limited to stationary use at home. Furthermore, fluid pump, fluid lines, and jets need to be thoroughly cleaned to avoid microbial growth. Moreover, the cost of an oral irrigator compared to the cost of regular dental floss tends to be prohibitive to many users.

Despite various approaches to improve the functionality and appearance of dental floss and floss containers, all or almost all of them fail to encourage a person to use dental floss. Thus, there is still a need to provide apparatus and methods to encourage use of dental floss.

### SUMMARY OF THE INVENTION

The present invention is directed to a method of encouraging use of dental floss. In one step a person is educated that the use of dental floss promotes health of teeth, and in another step, the education is coupled to providing dental floss in a container having a shape and color of a healthy tooth, thereby encouraging the person to use dental floss by displaying a desirable outcome of regularly using floss.

In one aspect of the inventive subject matter, the coupling comprises temporal, structural and proximal coupling, wherein preferred temporal coupling comprises educating and providing the person with the dental floss within 1 hour. Preferred structural coupling comprises providing a pictogram or printed instruction and presenting the pictogram or printed instruction on the container, and preferred proximal coupling comprises providing a printed instruction and presenting the printed instruction on a package enclosing the dental floss container.

In another aspect of the inventive subject matter, the step of educating comprises a pictogram or printed instructions, which may or may not be printed onto the floss container. In other aspects, the dental floss is preferably fabricated from nylon, polyethylene (PE) or polytetrafluoroethylene (PTFE), and the shape of the container has a shape of a triple-root molar, a double-root molar, a premolar or an incisor.

In a further aspect of the inventive subject matter, a dental floss is flavored with an aroma of a fruit, and a dental floss container has a shape of the fruit. It is generally contemplated that the aroma is artificial, and contemplated fruits include a strawberry, a raspberry, a cherry, a banana, a coconut, and an apple.

Various objects, features, aspects and advantages of the present invention will become more apparent from the following detailed description of preferred embodiments of the invention, along with the accompanying drawings in which like numerals represent like components.

### BRIEF DESCRIPTION OF THE DRAWINGS

FIG. 1 is a flowchart of a method of encouraging a person to use dental floss according to the inventive subject matter.

FIGS. 2A-C are perspective views depicting exemplary dental floss dispensers according to the inventive subject matter.

FIGS. 3A-F are side views of further exemplary dental floss dispensers according to the inventive subject matter.

### DETAILED DESCRIPTION OF THE PREFERRED EMBODIMENTS

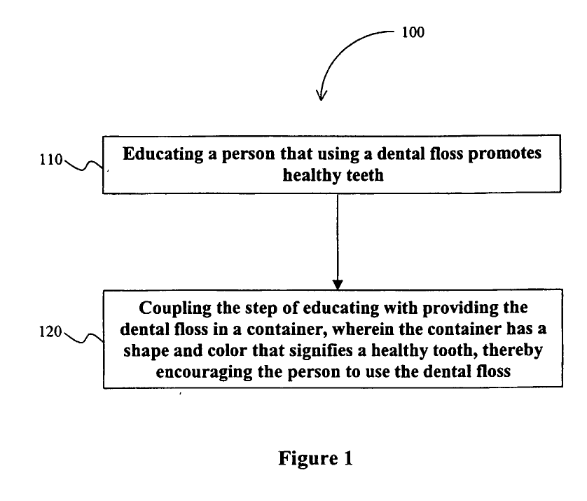

In FIG. 1, a general method 100 of encouraging a person to use dental floss has a step 110 in which the person is educated that using a dental floss promotes a healthy tooth, and another step “120 in which the education is coupled with providing dental floss in a container having a shape and color that signifies a healthy tooth, thereby encouraging the person to use the dental floss.

In a preferred aspect of the inventive subject matter, the person is a young teenager, which is educated by two pictograms depicting how to properly use dental floss and a brief printed statement that emphasizes that proper flossing reduces plaque formation and thereby promotes healthy teeth. Both the pictograms and the statement are preferably printed onto the dental floss container. The dental floss is a mint-flavored waxed nylon tape, and preferably disposed in a spool within a holding space of the dental floss container. The dental floss container has a shape of a double-root molar with an overall height of 4-5 cm, and a preferably white or slightly off-white color. The top portion of the container further has a lid that is movable between an open configuration and a closed configuration, and a portion of the dental floss that is not on the spool is accessible from the outside of the container when the lid is in the open configuration. The dental floss is cut from the supply on the spool utilizing a metal tongue that is coupled to the top portion of the container by cutting the floss in a movement of the floss relative to the container.

In alternative aspects of the inventive subject matter, it is contemplated that the user need not be limited to a young teenager, but may include various alternative members within the demographic spectrum. For example, it is contemplated that education of children age 5 to 12 years (i.e., while the children still have their baby teeth) is especially advantageous, because regular flossing habits may be engrained more effectively than in older persons. However, persons in the age group 13-30, and older are also contemplated.

With respect to the step of educating, it should be appreciated that many educational methods are appropriate, including interpersonal education, education on radio or television, or education by providing printed material. For example, a preferred interpersonal education may be an instruction on why and how to use dental floss by a dental hygienist, a parent, a schoolteacher, or even a member of the peer group of the person. Preferred education on radio or television may include an infomercial on why and how to use dental floss, preferably by a dentist or dental hygienist, and education by providing printed material preferably includes booklets, pamphlets, or flyers. One particularly preferred aspect of providing printed information is that the printed information is either disposed on the dental floss container, or a on a package enclosing the dental floss container. In cases where the printed information is disposed on the container or package, especially preferred information comprises a pictogram and/or written instructions on why and how to use dental floss. It is particularly contemplated that one goal of the education is a demonstration or description of the desired outcome of using dental floss, i.e., a picture, symbol, or description of a healthy tooth, wherein the picture, symbol or description is identical or exhibits strong resemblance to the shape and color of the dental floss container. Therefore, by educating the person on how and why to employ dental floss, and by demonstrating the desired outcome of regularly using dental floss, a dental floss container having shape and color of a healthy tooth will encourage the person to utilize dental floss. It should be especially appreciated that utilizing dental floss not only promotes healthy teeth, but also improves the health condition in body compartments other than the interdental space, including the gingiva, periodontal pockets, general oral cavity, and even the heart and lung [e.g., 111 effects of improper oral hygiene procedure. J Am Dent Assoc. 1980 Sep;101(3):476-80]. Moreover, in addition to a pictogram or printed information, motivational characters such as a smiley tooth (e.g., a pair of eyes over a smile flashing healthy teeth) may be displayed on the outer surface of contemplated dental floss containers. The education may further include providing information on differences in the material used for the dental floss, and information related to gingival health. Consequently, it is contemplated that appropriate dental floss in the dental floss container may be fabricated from a variety of materials, including natural and synthetic materials. For example, it is contemplated that appropriate dental floss is fabricated from nylon, PE, or PTFE. Moreover, contemplated dental floss may also comprise additives, including microbeads, a pharmacologically active substance, a substance or composition to enhance taste/flavor, an antibacterial substance, etc.

Where the step of educating is coupled in a temporal coupling to providing the dental floss, it is contemplated that educating and providing the person with the dental floss is preferably performed within one hour. However, in alternative aspects of the inventive subject matter, alternative times may include several minutes or hours, or one or more than one day may also be appropriate. Alternatively, where the step of educating is coupled in a structural coupling to providing the dental floss, it is contemplated that educational elements, including pictograms and printed instructions are provided, and that the educational elements are presented on the dental floss container.

In still other aspects of the inventive subject matter, where the step of educating is coupled in a proximal coupling to providing the dental floss, it is contemplated that educational elements, including pictograms and printed instructions are provided, and that the educational elements are presented on a package enclosing the dental floss container.

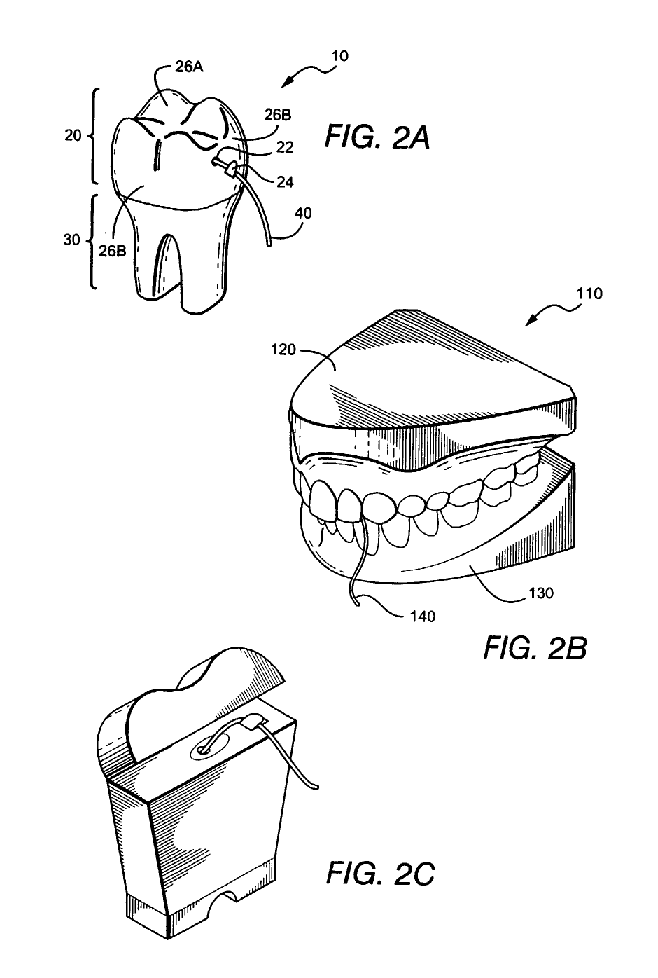

With respect to the shape and color of the dental floss container, it is especially contemplated that the shape of the container has a shape of a double-root molar, and a general representation of an exemplary tooth-shaped dental floss container is depicted in FIG. 2A. The tooth-shaped dental floss container 10 in FIG. 2A has an upper portion 20 and a foot portion 30. The upper portion has an upper surface 26A, and a plurality of sides 26B. On one side 26B of the upper portion 20 is an opening 22, through which dental floss 40 is threaded from a supply of dental floss (not shown) disposed within the container. A metal tongue 24 is situated next to opening 22, wherein the metal tongue can be used to hold and cut the dental 21 floss at a desired length by inserting the floss between the container and the tongue and tearing the floss by moving the floss relative to the container.

It should be appreciated, however, that the shape of the container need not be restricted to a double-root molar, but may in fact have a shape of a triple-root molar, a premolar, a canine, or an incisor. Although it is preferred that the proportions of the dental floss container are identical or at least similar to the proportions of a human tooth, it is contemplated that alternative proportions are also appropriate. For example, while some containers may have a foot portion that is shorter than the upper portion (e.g., the foot portion may have an overall length of between 0.9-0.1 times the overall height of the upper portion), other containers may have an extended foot portion that is longer than the upper portion (e.g., the foot portion may have an overall length of between 1.1-4.0 times the overall height of the upper portion), so long as the tooth shaped dental floss container still signifies a healthy tooth. The term “signifies a healthy tooth” as used herein means that the tooth is a visual representation of a teaching (i.e., education) of a healthy tooth. For example, where in the step of educating it is taught that a healthy tooth has a two white roots and a white upper portion, then a tooth shaped dental floss container with a foot having two white root shaped extensions and a white upper portion (as depicted in FIG. 2A) signifies a healthy tooth. It is further contemplated that even a relative abstract shape may be appropriate, so long as the shape still signifies a healthy tooth. Abstract shapes of teeth may be especially advantageous, where the container is formed from a flat pack dispenser, and an exemplary abstract shape is shown in FIG. 2C.

With respect to the material of contemplated dental floss containers, it should be appreciated that the material is not limiting to the inventive concept presented herein, and appropriate materials include natural and synthetic polymers, metals, and any reasonable combination thereof. For example, contemplated materials are polyethylene, polystyrene, and metals, including aluminum, chromium, and alloys.

In still further alternative aspects of the inventive subject matter, the shape of the dental floss container need not be restricted to a single tooth, but may comprise two or more teeth, and in an especially contemplated aspect the container may comprise a bitewing as shown in FIG. 2B. The bitewing 110 has an upper jaw 120 and a lower jaw 130, wherein the dental floss 140 is stored between the jaws (not shown), and the dental floss is pulled out from the container through the jaws, or through two teeth in the upper or lower jaw.

It should be especially appreciated that in alternative aspects of the inventive subject matter the foot may be sized and dimensioned such that the foot prevents water from being drawn via capillary action to the upper portion of the container, and especially contemplated feet have a height of at least 10%, more preferably at least 20% and even more preferably more than 40% of the overall height of the upper portion. Where protection of the contents of the tooth-shaped dental floss container from capillary water is especially desirable, it is preferred that contemplated containers have their largest horizontal circumference in a position on the upper portion other than where the upper surface of the upper portion joins the sides of the upper portion (e.g., a convex configuration of the sides). This configuration is especially advantageous where the dental floss container is utilized in a wet environment (e.g., a countertop in a bathroom), because the foot portion together with the point of largest circumference will position the upper surface away from a potential source of capillary water, when the container falls from an upright to a horizontal position. Thus, containers with convex sidewalls and a foot that is narrower than the footprint of the upper portion are especially contemplated herein.

In further alternative aspects of the inventive subject matter, the upper portion may have a lid that is movable between an open configuration and a closed configuration. Especially preferred lids are pivotably coupled to one side of the upper portion by a flexible connection that is preferably made from the same material as the container, and the upper surface of the lid may thereby have a shape and form similar to the surface (i.e., anatomy) of a tooth. Where the dental floss container has a lid, it is contemplated that the opening and the tongue are located on the upper surface of the upper portion of the container such that the opening and the tongue are covered by the lid when the lid is in a closed configuration.

With respect to the tongue, it is contemplated that in dental floss containers alternative mechanisms for cutting dental floss are also appropriate, and especially contemplated cutting mechanisms include devices in which the dental floss is cut without a movement of the floss relative to the container. For example, the foot portion and the upper portion may be movably coupled to each other such that the foot portion may partially slide into the upper portion. In this configuration, foot and upper portion may have an overlapping area, and within the overlapping area an opening in corresponding positions with a pair of blades attached thereto. When a floss strand is threaded through both openings, and the foot portion and upper portion are moved relative to each other the floss will be cut by the blades in a shearing-type movement.

In still further aspects of the inventive subject matter a person is encouraged to more regularly use dental floss by providing a dental floss with an aroma of a fruit, wherein the dental floss is at least partially enclosed by a dental floss container that has a shape of the fruit.

The dental floss is preferably a nylon dental floss 21 impregnated with an artificial strawberry aroma, and the dental floss container is a strawberry-shaped flat pack-type container with a snap type lid covering the area where the dental floss exits the container. It is also preferred that the strawberry-shaped container has a strawberry red color.

Various types of dental floss, techniques and aromas used to flavor dental floss are known in the art and are contemplated for use herein. Furthermore, the inventive subject matter is not limited to a particular type of dental floss, and a wide variety of dental floss other than nylon are contemplated, including cotton, PE, and PTFE. Likewise, various aromas other than an artificial strawberry aroma are appropriate, including natural and synthetic fruit aromas such as raspberry, cherry, banana, coconut, and apple aroma.

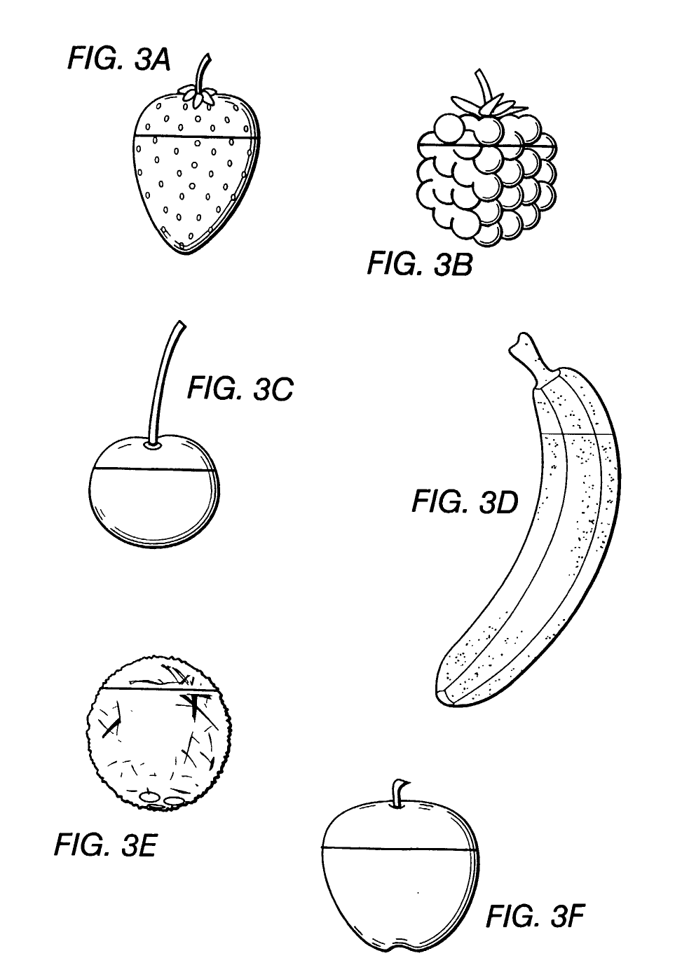

With respect to the dental floss container, it is generally contemplated that the shape of the dental floss container symbolizes a fruit, wherein the aroma on the dental floss determines the actual w fruit that is used for the container. For example, a banana-flavored dental floss has a banana-shaped dental floss container. Other contemplated shapes include a raspberry shape, a cherry shape, a strawberry shape, and exemplary fruit-shaped dental floss containers are shown in FIGS. 3A-F. Alternatively, non-fruit containers may bear resemblance to vegetables producing undesirable breath, including an onion or a garlic bulb, thereby reminding a person to use dental floss after a meal containing such vegetables. Where containers symbolize a fruit with a stem (e.g., a cherry or an apple), contemplated containers may further include in the stem a loop, opening or other element to which a key ring or suction cup may be affixed. Although a flat pack-type format for contemplated containers is preferred, other formats including injection molded or otherwise formed containers are also appropriate. With respect to additional elements, the same considerations apply as for the tooth-shaped dental floss container previously described.

In yet further alternative aspects of the inventive subject matter, the dental floss container may have the shape of a cartoon character. Cartoon character-shaped dental floss containers are especially advantageous, where it is an objective to motivate children to use dental floss more regularly. It is especially contemplated that cartoon character-shaped dental floss containers may be used in coupled with a teaching of a cartoon character to encourage using dental floss more regularly to render utilizing dental floss more appealing to children by providing a non-parental role model. For example, contemplated characters include Pokemon characters (e.g., Weepinbell, Tentacool, Geodude, etc.), Disney characters (e.g., Mickey Mouse, Goofy, The little Mermaid, etc.), Teletubby characters, Warner Brothers characters (e.g., Bugs bunny, Duffy Duck, etc.) and so forth. The teaching educates children that regularly using dental floss promotes healthy teeth, and may be provided by various methods, including TV-ads, printed booklets, flyers, stickers, etc. In further contemplated aspects, the dental floss in cartoon character-shaped dental floss containers may also be scented or aromatized to further increase the appeal of using dental floss. With respect to the step of coupling the teaching with providing the dental floss the same consideration apply as already described above for the coupling of the education with providing the dental floss in the method of encouraging a person to use dental floss.

Thus, specific embodiments and applications of apparatus and methods to encourage use of dental floss have been disclosed. It should be apparent, however, to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. A method of encouraging a person to use dental floss, comprising:
educating the person that using a dental floss promotes healthy teeth; and
coupling the step of educating with providing the dental floss in a container having a shape and color that signifies a healthy tooth, thereby encouraging the person to use the dental floss, wherein the container has an open configuration and a closed configuration, and wherein the dental floss is accessible in the open configuration, and wherein the container is formed from a tooth-shaped flat pack dispenser.

2. The method of claim 1 wherein the step of coupling comprises temporal coupling.

3. The method of claim 2 wherein the temporal coupling comprises educating and providing the person with the dental floss within 1 hour.

4. The method of claim 1 wherein the step of coupling comprises structural coupling.

5. The method of claim 4 wherein the step of educating comprises providing a pictogram, and wherein the structural coupling comprises presenting the pictogram on the container.

6. The method of claim 4 wherein the step of educating comprises providing a printed instruction, and wherein the structural coupling comprises presenting the printed instruction on the container.

7. The method of claim 1 wherein the step of coupling comprises proximal coupling.

8. The method of claim 7 wherein the step of educating comprises providing a printed instruction, and wherein the proximal coupling comprises presenting the printed instruction on a package enclosing the dental floss container.

9. The method of claim 1 wherein the dental floss is fabricated from a material selected from the group consisting of nylon, polyethylene, and polytetrafluoroethylene.

10. The method of claim 1 wherein the dental floss contains a pharmacologically active substance.

11. The method of claim 1 wherein the dental floss is flavored.

12. The method of claim 1 wherein the shape of the container has a shape of a triple-root molar.

13. The method of claim 1 wherein the shape of the container has a shape of a double-root molar.

14. The method of claim 1 wherein the shape of the container has a shape of a premolar.

15. The method of claim 1 wherein the shape of the container has a shape of an incisor.

16. The method of claim 1 wherein the container is fabricated from a material selected from the group consisting of polyethylene, polystyrene, and a metal.

17. A method of motivating children to use dental floss more regularly, comprising:
providing a teaching by a cartoon character that regularly using dental floss promotes healthy teeth; and
coupling the step of teaching with providing the dental floss in a container having a shape of the cartoon character, wherein the container has an open configuration and a closed configuration, and wherein the dental floss is accessible in the open configuration, and wherein the container is formed from a tooth-shaped flat pack dispenser.

18. The method of claim 17 wherein the cartoon character is a Pokemon character.

19. The method of claim 17 wherein the cartoon character is a Disney character.

20. The method of claim 17 wherein the dental floss is scented.
